(19) United States
(12) Patent Application Publication
(10) Pub. No.: US 2010/0191675 A1
(43) Pub. Date: Jul. 29, 2010

(54) WIRELESS POSITIONAL BASED ROUTE TOLLING

(76) Inventor: Walter Steven Rosenbaum, Paris (FR)

Correspondence Address: DICKINSON WRIGHT PLLC, 1875 Eye Street, NW, Suite 1200, WASHINGTON, DC, 20006, US

(21) Appl. No.: 12/693,937

(22) Filed: Jan. 26, 2010

Related U.S. Application Data
(60) Provisional application No. 61/147,319, filed on Jan. 26, 2009.

(51) Int. Cl. G06F 17/00; G01S 3/02

(52) U.S. Cl. 705/417; 342/451

(57) ABSTRACT

A system for determining a distance a vehicle transits within a road system has a mobile device and a main processing unit. The mobile device has a device identification signature and a processing unit to process wireless communication signals received from a network of base stations having positional coordinates, each base station having a base stations identity signature. The processing unit creates data sets containing the base stations identity signatures, and a base station transmits the sequence of data sets. The main processing unit is configured to receive the sequence of data sets and to associate the base stations identification signatures to the positional coordinates of the base stations, to perform trend analysis upon the positional coordinates, to determine a change in trend, to set route positional coordinates at a change in trend, and to determine the distance taking the set route positional coordinates and the road system into account.

### CROSS-REFERENCE TO RELATED APPLICATIONS

The application claims the benefit of Provisional Application No. 61/147,319, filed Jan. 26, 2009, the disclosure of which is fully incorporated herein by reference.

### BACKGROUND OF THE INVENTION

The various embodiments described herein relate to determining a distance an object travels. More particularly, these embodiments relate to determining the distance a vehicle transits on a road for the purpose of charging a fee for the traveled distance.

Charging a fee for a traveled distance is referred to as tolling. Tolling has evolved significantly in the last years and is viewed in many developed countries as not only a revenue tool but also a key factor in changing travel habits to reflect environmental constraints. Historically tolls were collected as part of the business proposition for building and maintaining private roads. Such roads were not uncommon entrepreneurial activities in the United Sates in the pre and immediately post Revolutionary period in states like Pennsylvania. Tolls were collected by a toll keeper on a one-on-one basis for each transit and amounts reflected whether the passage was by foot, horse or carriage.

In 19^{th} and mid-20^{th} century setting the idea of tolling became mainly the prerogative of state and federal government as in developed countries massive road networks were built and needing a revenue base. As traffic grew in the latter part of the 20^{th} century, the cost of tolls became less of the issue but rather the delays caused by “toll collection islands” that caused literally miles of backup during rush hour. The more complicated the tolling procedure like accounting for distance traveled, weight, number of axles etc, the longer the lines and traffic backup. The first approaches to the dual problem of revenue collection and traffic snarls were expedient rather than revenue accounting based such as providing decals indicating prepaid tolls. More streamlined and precise tolling followed by designating certain lanes “vehicle only,” or “exact change.” Another approach limited tolling delays to only one direction by collecting a double toll allowing one payment cover both directions. These schemes gave minor improvement as long as people had to come to a stop as they paid the toll.

The desire to improve toll collection while minimizing delay led to automatic collection where coins were thrown into a hopper and automatically tabulated before a gate was lifted. Although this saved labor of toll collection personnel, it did not really reduce backup and was only of use when tolls were conveniently met with pocket change. Once paper money was required to meet the denomination, automatic toll collection was no longer viable.

Most recently, tolling to avoid traffic congestion at toll gates and also to reduce labor cost has transitioned the use of transponders sometime called active RFID. As embodied in the commercial products such as: EZPass® and FasTrack®, tolling is transacted when a vehicle with such a transponder passes through an antenna equipped gate. A signal is sent via the antennas in the gate that activates the transponder/RFID in the vehicle that in turn responds with a radio signal containing an identification number that corresponds to an account from which the toll is debited.

Although the generic transponder based solution can handle seamlessly tolling, it is a discrete detection scheme that only registers a vehicle's presence but gives no contiguous tracking information. For more recent concepts of tolling that are, for example, designed to be applied to dense urban and business areas, where route and mileage would be the key constituents of a tolling structure, continuous tracking is required. For such a continuum requirement, transponder based tolling using gates alone does not provide the required information and propagation of sufficient gates to provide route information would be impractical. Ideas of using GPS to provide tracking, in turn, raise questions of privacy.

US 2003/0115095 (Yamauchi) and EP 1 623 387 B1 (De Bonnenfant) describe a procedure that utilizes the GSM network for monitoring cars that enter and leave a tolling zone. A mobile-phone like device reacts to a signal from a tolling zone GSM base station and dials a chargeable number. This procedure is repeated at certain intervals while the mobile device is within the tolling zone. In short, the tolling is basically switched on and off via the GSM network and the tolling is effected via chargeable phone numbers. Since specified base stations have to be identified as being part of a tolling zone, this method requires either a priori cooperation on the part of the GSM service providers since their communication signals would have to act as carriers of tolling zone identifier signals, or base station IDs for the tolling zone identifying base stations will have to be uploaded to the mobile device, which will make updating for new tolling zone areas a very clumsy procedure.

Further, before a tolling region can be specified as a GSM signal domain, signal strength assessments need to be taken in the field. These can tend to be highly variable due to atmospheric conditions and even weather. Furthermore as a tolling area becomes larger—such as nationwide—such a priori measurements become impractical. Managing tolling via a chargeable number makes the system also prone to failures in the phone network that may prevent calls at the proper moment due to caller overload.

Since the GSM base stations that is used by a mobile phone does not necessarily have to be the base station with the closest geographical proximity, but may also be—due to reduced base station capacity—a base station with a more remote location, the correspondence between base stations contacted and a certain geographical toll zone can not be guaranteed.

Furthermore, the need to initiate from the tolled vehicle in these systems a GSM communication to the tolling system in each of the GSM base station domains implicitly provides vehicle tracking within the nominal triangulation accuracy associated with GSM signal handing. This erodes privacy during the tolled transit.

US 2003/0216857 (Feldman et al.) describes a system that uses the GSM network to locate a vehicle and then applies street map and traffic data to calculate possible future routes for optimized travel time of a predetermined distance. This system is concerned with projecting possible routes the car may take in the future and selecting an optimal normalized travel time for a pre-defined distance.

### SUMMARY OF THE INVENTION

It is an object of the invention to provide a system and a method for determining a distance a vehicle transits that can be implemented without complicated installation procedures, e.g., on a vehicle. It is a further object of the invention to provide a system and method for determining a distance a vehicle transits while not unduly invading the privacy of a driver or passengers.

Accordingly, one aspect involves a system for determining a distance a vehicle transits within a road system. The system has a mobile device and a main processing unit. The mobile device has a unique device identification signature and is configured to be attached to the vehicle. Further, the mobile device includes a processing unit configured to process wireless communication signals received from a network of stationary base stations having known positional coordinates and each having a unique base stations identity signature encoded into its communication signals, wherein each received communication signal has a signal strength, the processing unit further configured to process the communication signals to create data sets containing the base stations identity signatures. A memory is coupled to the processing unit and configured to store data sets selected in a way that a sequence of recording these data sets is maintained. A transmitter is coupled to the processing unit and configured to transmit the sequence of data sets in a way that associates the transmitted data sets to the device identification signature. The main processing unit has a receiver configured to receive the sequence of data sets transmitted by the mobile device, and a processor coupled to the receiver and configured to associate the base stations identification signatures to the positional coordinates of the base stations, to perform a trend analysis upon the positional coordinates, to determine a change in trend, to set route positional coordinates at a change in trend, and to determine the distance the vehicle has transited within the road system taking the set route positional coordinates and the road system into account.

Another aspect involves a method of determining a distance a vehicle transits within a road system, wherein the vehicle is provided with a mobile device, the method receives via the mobile device wireless communication signals from a network of stationary base stations having known positional coordinates, each base stations having a unique identity signature encoded into its communication signal. The signal strengths of received communication signals are measured, and the signal strengths are associated with the identification signatures of the base stations from which the communication signals originate. Each base station's identification signature is associated to the positional coordinates of the base station. A trend analysis is performed upon the positional coordinates to determine a change in trend, and route positional coordinates are set at a change in trend. The distance the vehicle transits within the road system is determined taking the set route positional coordinates and the road system into account.

The geographical coordinates of the individual base stations making up this network are known, each individual base station having a limited communication signal range and being identifiable via an individual identification signature encoded in its communication signals. A well known example for such a network is a network of GSM base stations.

The mobile device, while the vehicle it is attached to transits the network, constantly monitors signals received from the individual base stations of the network. The mobile device is capable of processing the signals from the base stations to extract the individual signature of each received base stations from the signal and to measure the individual received signal strength in a way that associates for any given moment the identification signal of a base stations with the received strength of its signal. The term “received signal strength” refers to the fact that the mobile device does not measure the strength of the signal as it was emitted by the base stations, but only the strength of the signal, when it reaches the antenna of the mobile device.

While the vehicle transits the network, the mobile device constantly monitors the signal strength of the received signals. The processor of the mobile device searches for the strongest received signal and creates a data set that contains the signature of the base stations that has sent this signal. The data set is stored in the memory of the mobile device. When the recorded signal transmitted by a base station is detected to be stronger than the signal of the base station whose signature has been recorded in the previous data set, a new data set is created, containing the signature of the base stations associated to the stronger signal.

In this way, a sequence of data sets is generated and stored in the memory of the mobile device, each data set containing the signature of the base station whose signal, at the time and location of recording, was the strongest of the received signals. This sequence of data sets is uploaded to the main processing unit, wherein the base station's signature contained in each data set is used to derive the geographic coordinates of the base stations, for example, by looking up in a list or a data base.

In the sequence recordings are made, a least-squares or other applicable regression fit between the individual geographical coordinates extracted from the recorded data sets transmitted by the mobile device is performed. As successive base station coordinates are added the regression coefficient is seen as developing a trend in correlation to the vehicle's direction smoothing out specific, e.g., GSM base station deviation from the directional path that the vehicle is transiting.

As long as the vehicle carrying the mobile device is traveling in approximately the same direction, the regression coefficient remains either stable or approaches a value of 1 or whatever coefficient in the regression analysis represents a high correspondence with a trend. Successive coordinate points belonging to such a sequence are considered to belong to the same directional trend.

If the regression coefficient shows a decrease relative to the previously stable values over a certain number of data sets, it is assumed that the vehicle has changed its direction. In this case the previous directional trend is considered to have ended with the last coordinate point that was registered before the regression coefficient started to decrease.

The first of the succession of coordinate points showing a relative decrease is then considered to be the first coordinate point of a new directional trend and its coordinates are used to start a new regression coefficient calculation of a directional trend. The system then considers the first coordinate points of subsequent directional trends and calculates the shortest possible route a vehicle can take between them while using the corresponding road system and observing traffic restrictions such as one way streets etc. Systems that compute such routes are well known and used by services like MapQuest®.

For coordinate points that are not accessible by road the point of closest proximity is chosen that is still accessible by road. In this way, the overall route of the vehicle is segmented into individual directional trends, each directional trend represented by a stable regression coefficient. For each directional trend the shortest reasonable road distance is computed, between the first coordinate point of the directional trend and the first point of the next trend, which is called a distance segment. The sum of these distance segments represents the overall distance the vehicle has transited.

### BRIEF DESCRIPTION OF THE SEVERAL VIEWS OF THE DRAWINGS

The novel features and method steps characteristic of the invention are set out in the claims below. The invention itself, however, as well as other features and advantages thereof, are best understood by reference to the detailed description, which follows, when read in conjunction with the accompanying drawings, wherein:

FIG. 1 shows an illustration of one embodiment of a mobile device;

FIG. 2 shows an illustration of one embodiment of a main processing unit;

FIG. 2b shows an illustration of one embodiment wherein a main processing unit is integrated into a mobile device;

FIG. 3 shows an illustration of one embodiment of a sequence of operations performed by the mobile device;

FIG. 4 shows an illustration of one embodiment of a sequence of operations performed by the main processing unit;

FIG. 5 shows an illustration of one embodiment of a vehicle equipped with a mobile device of FIG. 1 and moving within a network of streets 14;

FIG. 6 shows an exemplary route a vehicle travels within a network of streets; and

FIG. 7 shows an exemplary street map and a route of FIG. 2 after ascribing base stations identification signatures.

### DETAILED DESCRIPTION OF PRESENTLY PREFERRED EMBODIMENTS

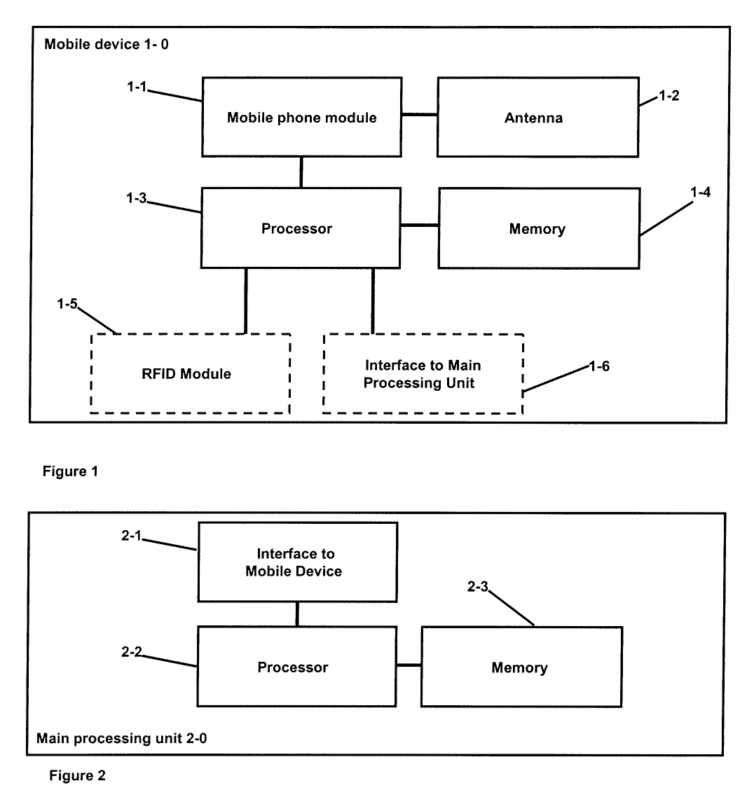

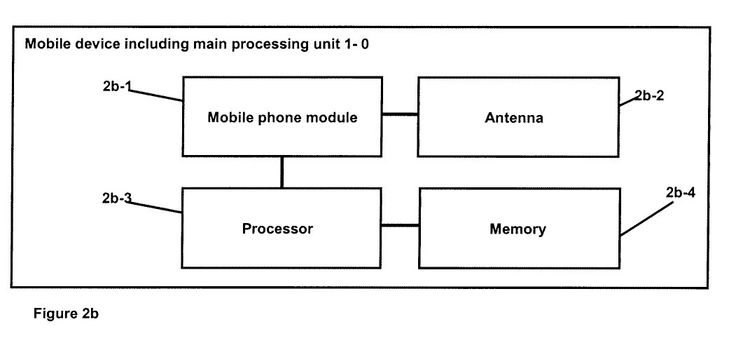

FIG. 1 and FIG. 2 show two components of a system for determining a distance an object, such as a vehicle, transited within a system of paths, such as a road system. Hereinafter, the object is a vehicle that travels along a route within a road system. The system includes a mobile device 1-0 attached to the vehicle and the main processing unit 2-0.

FIG. 1-1 shows an illustration of one embodiment of a mobile device 1-0 having a standard chip set, 1-1, an antenna 1-2 connected to the chip set 1-1, and a processor 1-3 also connected to the chip set 1-1. Further, the mobile device 1-0 includes a memory 1-4 connected to the processor 1-3. In one embodiment, the mobile device 1-0 may include an RFID module 1-5 for near field communications and an (hardware) interface 1-6 to the main processing unit 2-0, both of which are connected to the processor 1-3 and shown with dashed lines in FIG. 1-1.

Examples for the type of chip set 1-1 used in the mobile device 1-0 are the MT® series from METITECH® and the LoCosto® series from TI®. However, it is contemplated that other commercially available chip sets or types of chip sets may be used as well.

The chip set 1-1 is configured to receive via the antenna 1-2 communication signals, herein also referred to as signals, from a network of stationary wireless transmitters (not shown in FIG. 1). These transmitters are referred herein as base stations. The geographical position of each of these base stations is known and recorded in the memory 2-3 of the main processing unit 2-0 shown in FIG. 2. Also, each of these base stations can be individually identified by an identification signature encoded into its signal. Hereinafter, this is referred to as base station identification signature or signal identification signature. Such a network may, for example, be a network of mobile phone base stations. The properties of such base station systems and the chip sets that transmit, receive and decode (RF) signals are well known and not described herein. It is contemplated that in one embodiment the chip set and the antenna are replaced with a standard mobile phone module, which includes both of these components.

The chip set 1-1 is configured to continuously receive signals from more than one of these base stations at the same time. It measures individually the signal strength of each received signal and derives from each signal the identification signature of the base station that has sent the signal in a way that associates a strength value of a received signal with the identification signature of its base station. The signal strength is measured via RSSI (Received Signal Strength Indicator). However, other methods of measuring received signal strengths are not excluded and are also within the scope of this patent.

As the vehicle transits the network of base stations, the mobile device 1-0 receives signals from varying base stations with varying received signal strength values. This data (signal strength and base station identification signature) is upon reception transferred to the processor 1-3. The processor 1-3 is configured to apply pre-defined rules to the data monitored by the chip set, to select base station identification signatures and other data components according to these rules, and to store them in successive data sets in the memory 1-4 in a way that associates each base station's identification signature with its respective signal strength value. The memory 1-4 serves as a RAM for operations performed by the processor 1-3.

In one embodiment, the processor 1-3 selects the base station's identification signature whose associated signal has the highest communication signal strength value compared to all other communication signals received at the same time and creates a data set containing the identification signature of this base station. This data set is then stored in the memory 1-4. In the following description the term “data set” applies to individual units of associated data created by the processor 1-3 and stored in a data base of the memory 1-4.

When another received signal associated with a different base station identification signature is measured with a higher signal strength value than the previous one, the processor 1-3 generates another data set containing the identification signature associated to that signal and adds it to the memory 1-4.

In case two or more received communication signals either show the same signal strength value or show a signal strength value difference that is lower than a pre-defined threshold, the identification signatures of all these communication signals are stored in the same data set. If a continuous monitoring procedure shows that all signals are lost or that suddenly the received strength value of all or selected signals drops below a pre-defined threshold a data set is created containing information indication to this situation. In this way a sequence of data sets is generated, each one either containing the identification signature associated to the received signal that had the highest received strength value at the time of recording, or an indication of signal reception failure.

The sequence of the data sets reflects the sequence of the recordings. Each data set therefore is provided with an index signature, such as, for example, a time stamp, that allows clear identification of its place in the sequence of recordings, such as the Time of Arrival (TOA).

In another embodiment, the consecutive data sets containing the identification signatures associated with the strongest signal values are created by the processor 1-3 according to other rules, for example, according to a time schedule or according to pre-defined changes in the spectrum of received signals. Such changes could be, for example, the disappearance of a signal or the appearance of a new one or changes in the difference between received signal strength values. It is contemplated that other changes may be selected.

In another embodiment the two embodiments described above are used in combination.

In another embodiment, the Time of Arrival (TOA) of the signal at the mobile device 1-0 is stored in the data set additionally to the identification signature associated with the communication signal. In one embodiment, the time at which the data set is created by the processor 1-3 is stored (time stamp) in the data set additionally to the identification signature associated with the signal.

In another embodiment, not only the identification signature associated with the strongest received signal value is stored in the data set, but also the identification signatures associated with other signals that are received at the time of recording. The number of signatures stored may be limited to a predetermined number, or may include the signatures of all available signals. It is also possible that the base stations identification signature associated with a signal is only recorded when the received signal strength exceeds a certain pre-defined threshold value.

In another embodiment the received strength value of the signal or signals associated with the identification signature or signatures stored in the data base are also stored in the data base of the memory 1-4 in a form that associates the stored received signal strength and other timing characteristics with its respective identification signature.

In another embodiment, the TOA, respective base station identification signature and respective received signal strength of the signal are stored together. Other data contained in the received signal or signals may also be stored in the data set additionally to the parameters mentioned above. Such data can be, for example, the time at which the base station has sent the signal, Angles of arrival (AOA) and/or other parameters.

The processor 1-3 is configured to retrieve under certain pre-defined conditions data sets, either individually or in clusters, from the memory 1-4 and transmit them to the main processing unit 2-0 detailed in FIG. 2.

In a preferred embodiment the chip set 1-1 is configured to transmit these data sets, either individually or in clusters retrieved by the processor 1-3 from the memory 1-4 via the antenna 1-2.

In another embodiment, the RFID module 1-5 receives a signal from an RFID reader. This signal is transferred to the processor 1-3 which then proceeds to retrieve data sets from the memory 1-4. These are then either written to the RFID module 1-5 to be read by an RFID reader or transmitted via the chip set 1-1.

The data transmission to the main processing unit 2-0 may be made via the interface 1-6. This can be another standard chip set, a wireless transmitter, an interface to the internet, such as a modem. It can also be an interface to a mobile data carrier such as an USB stick.

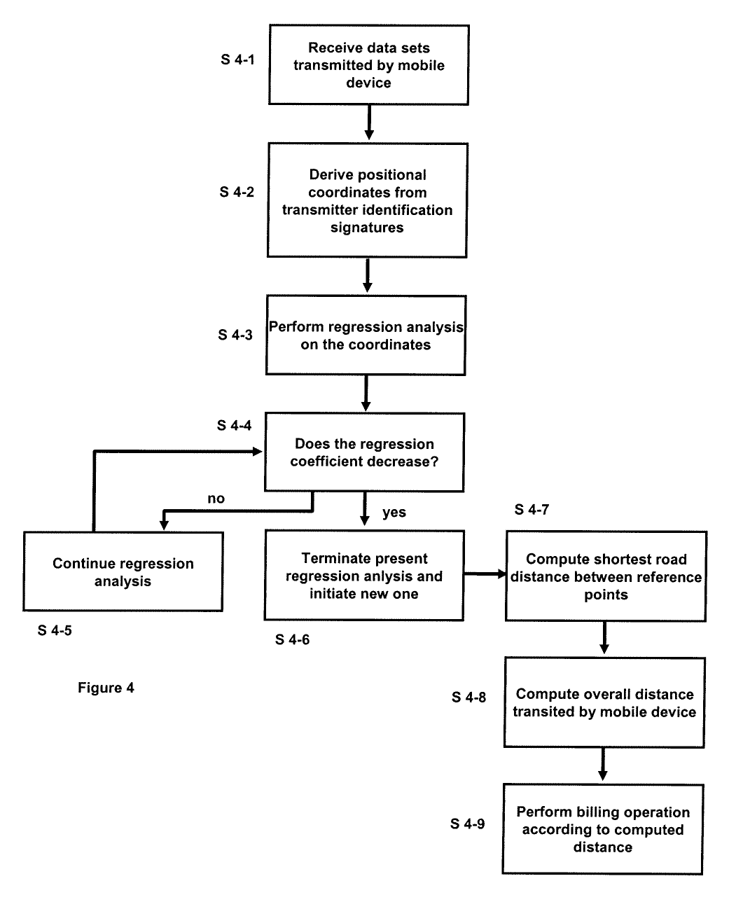

While in one embodiment the mobile device 1-0 is used to monitor and collect data and the processing of the data according to the method described in FIG. 4 is done in a remote main processing unit 2-0, in another embodiment all data processing can be performed by the processor 1-3 of the mobile device 1-0. In this case, the processing unit 2-0, including all its components is considered to be integrated into the mobile device 1-0, except the billing information and the mapping information contained on the memory 2-3. Also, the mobile device 1-0 is configured to transmit the results of the data processing via the below-described method to a facility tasked with performing the billing operation.

FIG. 2 shows an illustration of one embodiment of a main processing unit 2-0, which contains a communication signal interface 2-1 to the mobile device 1-0, a processor 2-2 connected to the communication signal interface 2-1, and a memory connected to the processor 2-3. It is contemplated that the various devices, whether mobile or stationary, either include a power source or are connected to a power source. The interface 2-1 is configured to receive data sets transmitted by the mobile device 1-0, in which case it is also a standard chip set.

The memory 2-3 is configured to store the following information to be accessed by the processor 2-2:
i. Geographical coordinates associated with the base stations identification signatures.
ii. Billing information associated to the mobile device identification signature. Such billing information could be, but is in no way restricted to, the name and address of a vehicle's owner, account numbers, or any registration number.
iii. Map information: Such information should allow determination of the relative position of given geographical coordinates to the network of roads the vehicle carrying the mobile device 1-0 has transited. It should also allow determination of the distance of a route taken by road between two points defined by geographical coordinates. Lastly, it should contain information about traffic restrictions such as one way streets etc.

The memory 2-3 also serves as a RAM for the operations performed by processor 2-2.

The processor 2-2 is configured to perform on the data sets received from the mobile device 1-0 the operations detailed in the embodiments of the method detailed in FIG. 4.

While in the preferred embodiment the mobile device 1-0 and the main processing unit 2-0 are separate, in another embodiment the main processing unit 2-0 is integrated into the mobile device 1-0 as shown in FIG. 2b.

In this configuration the chip set 2b-1 and the antenna 2b-2 perform the functions of the chip set 1-1 and the antenna 1-2. The processor 2b-3 performs the operations of processor 1-3 and the functions of processor 2-2, the memory 2b-4 performs the functions of memory 1-4 and the functions of memory 2-3.

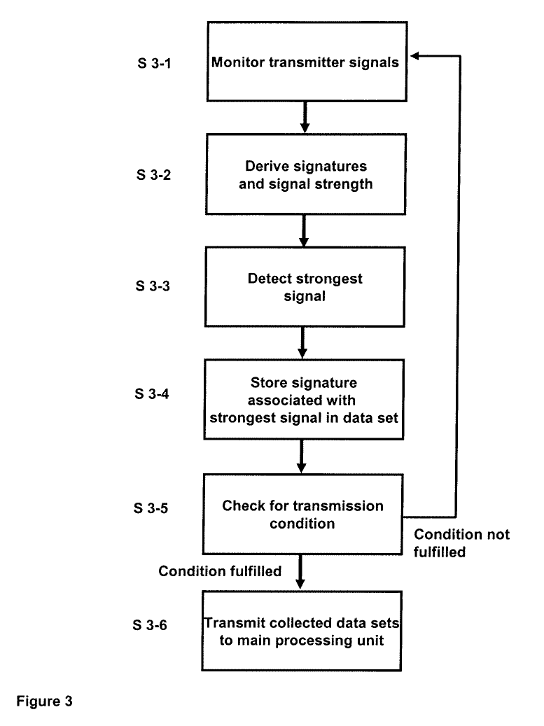

FIG. 3 shows a diagram of operational steps of one embodiment of a method performed by the mobile device 1-0. The operation depicted is continuous; it starts when the mobile device 1-0 is activated and ends when it is deactivated.

In a step S 3-1, the chip set 1-1 continuously monitors available signals transmitted by the system of base stations. The possibility of reception conditions causing reception of signals from a base station far away from the plot of points can be filtered by removing from consideration an anomalous base stations over a predetermined distance from the track of prior coordinates which would be a physically impossible distance for the vehicle to have transited between monitored base stations.

In a step S 3-2, the chip set 1-1 derives the base stations identification signature encoded in each signal and measures the received signal strength value of each signal. The received strength value of each signal and the base stations identification signature of each signal are associated so that for every given time of reception there exists a set of base stations identification signatures associated to the respective signal strength values. The set of signal strength values associated with the respective base stations identification signatures of all signals received by the chip set 1-1 at a given time is transferred to the processor 1-3.

In a step S 3-3, the processor 1-3 selects from this set the signal with the highest signal strength value.

In a step S 3-4, the base stations identification signature associated with the signal selected in step S 3-3 is stored by the processor 1-3 in the memory 1-4 in the form of a data set. This storage has to be performed in a way that upon retrieval the place of an individual recording within the sequence of recordings can be unequivocally reconstructed.

In a step S 3-5, the processor 1-3 checks whether the condition for communication signal of the data sets collected in memory 1-4 is fulfilled. In one embodiment, the data communication signal between the mobile device 1-0 and the main processing unit 2-0 is initiated according to a certain time schedule controlled by the processor 1-3 in the mobile device 1-0, for example once a month. In another embodiment, this data communication signal is initiated by one or more pre-defined rules, for example, when a certain storage volume in the memory 1-4 has been achieved of the mobile device 1-0.

In another embodiment, the data communication signal is initiated by a signal transmitted to the mobile device 1-0 either directly from the main processing unit 2-0 or by some other external facility. In yet another embodiment the data sets are not batched in the memory 1-4 of the mobile device 1-0 but are transmitted directly after recording to the main processing unit 2-0. This may be the case if the main processing unit 2-0 is integrated into the mobile device 1-0 but is also an option when it is situated in a remote facility. The data sets transmitted by the mobile device 1-0 are associated with the mobile device identification signature in a way that, for each data set or cluster of data sets, the mobile device 1-0 that has sent these data can be identified.

FIG. 4 shows a diagram of operational steps of a preferred embodiment of a method performed by the main processing unit 2-0. In a step S 4-1, the data sets transmitted by the mobile device 1-0 are received together with the mobile device identification signature and transmitted.

In one embodiment, the communication signal of the data sets collected by the mobile device 1-0 to the main processing unit 2-0 is performed via the mobile phone network. In another embodiment, this communication signal is performed via RFID. In this case the mobile device 1-0 needs to be equipped with an RFID module 1-5 that interacts under certain conditions with an external RFID reader.

In another embodiment, the data collected by the mobile device 1-0 may be written to a removable storage medium that is then used to transport the data to the main processing unit 2-0. In another embodiment the mobile device 1-0 may be permanently or temporarily connected to a communication network, such as the Internet, a phone network or a similar information transporting network, which is then used to upload the data to said network and then transfer it to the main processing unit 2-0. The data is then transferred to the processor 2-2.

In a step S 4-2, the processor 2-2 then accesses the memory 2-3 that contains positional coordinates of the base stations associated with their individual base stations identification signatures. The processor 2-2 uses the base stations identification signatures contained in the data set provided by the mobile device 1-0 to retrieve from memory 2-3 the respective positional coordinates of the base stations.

These can be an x-y coordinate system, a longitude-latitude coordinate system or any other coordinate system. These coordinates are available in a list or data base associated with the base station signatures in a way that allows upon entry of the base stations signature the retrieval of the respective set of coordinates.

In one embodiment, these sets of coordinates represent the geographical coordinates of the base stations whose received signals had the highest signal strength values at the time of recording. However, if two or more received signals have the same or only slightly different signal strength values, the respective data set contains the identification signatures of all these signals. In this case the coordinate sets derived for the individual signatures are combined in a way that results in one combined average coordinate set.

In one embodiment this derivation of positional coordinates from the base stations identification signatures as well as the subsequent processing steps are performed by the main processing unit 2-0 using a data base or list that associates base stations identification signatures with the respective positional coordinates of the base stations stored in the memory 2-3.

In another embodiment, the derivation of positional coordinates may be performed by one or more remote facilities or services. In this case the system is configured to transmit the base stations identification signatures to the remote facility or service and receive and integrate the processing result.

The processor 2-2 also retrieves information about the sequence in which the data sets were stored by the processor 1-3 in the memory 1-4, which represents the sequence in which the respective signals were received by the chip set 1-1.

While in one embodiment the operation proceeds to the next step using these base stations coordinates, in another embodiment the base stations coordinates are used in conjunction with the respective received signal strengths to derive the positional coordinates of the mobile device 1-0 and thus the vehicle carrying it, at the moment of recording. These coordinates are then used in this embodiment for the next operational steps.

In another embodiment, the coordinates of the mobile device 1-0 computed in this manner may be used, in addition to and as a complement to the use of the base stations coordinates, as reference coordinate points.

In as step S 4-3, the processor 2-2 proceeds to perform on the positional coordinates in the sequence of their reception by the mobile device 1-0 an analytic procedure that results in an approximation of the distance that the vehicle carrying the mobile device 1-0 has transited in a given area.

In one embodiment a least squares or any other regression fit that allows detecting a trend in a set of successive data is applied to the coordinates derived from the successive data sets transmitted by the mobile device 1-0:

$$\hat{β} = \frac{{\sum }_{i = 1}^{n} {x}_{i} {y}_{i}}{{\sum }_{i = 1}^{n} {x}_{i}^{2}}$$

wherein x and y are the derived coordinates and i=1 . . . n is the position of the respective data set within the series of recordings analyzed by this regression fit. As successive sets of coordinates are added to this equation the regression coefficient is seen as developing a trend in correlation to the vehicle's direction.

In a step S 4-4, the processor 2-2 checks, for every added set of coordinate points, whether the regression coefficient is stable, increases toward 1 or decreases. A regression coefficient that is stable or increases towards 1 indicates travel of the vehicle carrying the mobile device 1-0 in approximately the same direction over all coordinate points. In this case, in step S 4-5, the regression analysis is continued with the next set of coordinates.

A decreasing regression coefficient indicates a change in direction, which may indicate a change of direction in the vehicle's course. When such a decrease is observed, in step S4-4, it is examined whether the decrease continues with subsequent coordinate sets. A given quota of such decreasing coordinate set regression computations (e.g., three successive coordinate sets) is assumed to indicate a change of direction.

If the decrease observed in step S 4-4 does not continue for the quota, the regression analysis is continued in step S 4-5 with the next set of coordinates. If the decrease observed in step S 4-4 does continue for the quota, the regression analysis is continued in step S 4-5 with the next set of coordinates, and the procedure continues to a step S 4-5.

To make the regression computation more sensitive to such a change in sense of direction, the base regression computation in step S 4-3 can be made a “rolling computation” of the last “n” cell base stations where “n” can be a value such as 10 determined by experimentation to result in a stable yet sensitive regression computation.

If a decrease is determined to be continuous in step S4-4, the trend previously observed in the regression computation is considered to have ended and the first coordinate set that caused the continuous decrease in the regression coefficient is used as the first set of coordinates for a new regression analysis in step S 4-3. Thus, in this step, the sequence of coordinate sets derived from the communication signals from the mobile device 1-0 is segmented into subsets of successive coordinate sets, each segment defined by a stable regression coefficient and representing a directional trend and referred to as directional segment.

If the processing comes across a data set that does not contain a base stations identification signature but an indication of a loss of signal contact, this situation is treated as the termination of a directional segment, the next segment starting with the next data set after return of signal contact.

In a step S 4-7 a road distance is ascribed to each of these directional segments. This is done by computing a route a vehicle can take between two coordinate points that are used as reference points while using the corresponding road system and observing traffic restrictions such as one-way streets etc. Systems that compute such routes are well known and used by services like MapQuest®.

In one embodiment, the route computation operation is performed by the processor 2-2 of the main processing unit 2-0 using the map information. The processor 2-2 accesses the map information stored in the memory 2-3. The map information contains data regarding the network of roads the vehicle carrying the mobile device 1-0 has traversed during the time of signal recording, such data being coordinates of roads, distances and traffic regulations. This information is processed by the processor 2-2 in a way that the input of two or more positional coordinate points extracts the distance a vehicle travels to get from one coordinate point to the other while observing traffic regulations. For coordinate points that are not accessible by road the point of closest proximity is chosen that is still accessible by road.

In one embodiment the connected reference points are the first coordinate point of a directional segment and the first coordinate point of the next directional segment. In another embodiment the first and the last coordinate points within a directional segment are connected to compute the distance within a directional segment and the last coordinate point of a directional segment and the first coordinate point of the next directional segment are connected to compute the distance from one directional segment to the next. In another embodiment, additionally to the coordinate points that define intra- and inter directional segment distance, other coordinate points inside a directional segment are also taken into account for computing the road distance.

While in the preferred embodiment the road distance computed is the shortest one, in another embodiment it is an average road distance. One possible way to achieve this is to compute between two reference coordinate points all or a selection of possible routes that may be taken while using the corresponding road system and observing traffic restrictions such as one way streets etc.

In another embodiment, more than two reference points can be taken into account for this computation. For example, one selection criterion for possible routes can be that they come close to or touch these additional points. The final road distance for each directional segment is then computed as a mean distance of the selected possible routes.

While in one embodiment only geographical coordinates derived from the identification signals and the sequence of the signals is used to compute the road distance, in another embodiment also the time of the Time of Arrival (TOA) of the signal at the mobile device 1-0 is stored and used in the computation of the route. This data regarding the time of recording allows determination not only of the distance the vehicle carrying the mobile device 1-0 has traveled, but also how fast it has traveled this distance. Also, according to an above-described embodiment, the data regarding the time of recording can be applied to select or exclude certain routes from a multitude of possible routes used for computation of an average distance.

In another embodiment the time data can be applied to select or exclude certain routes from a multitude of possible routes used for computation of an average distance. If the received base station identification signatures and their respective received signal strength values do not change over a pre-defined time span or a pre defined number of data sets, this is seen as an indication that the vehicle carrying the mobile device 1-0 has not moved during the recording of the data sets.

In one embodiment additional data contained in a communication signal or gathered by processing and analyzing a communication signal and stored in a data set can be applied for positioning or route selection and/or verification of the route selection and/or verification directional changes determined via the trend analysis. Such data can be, for example, the time the signal has been sent by the base station, or the Angle of arrival (AOA) of the communication signal at the mobile device 1-0.

In one embodiment determination of relative position between a base station and the mobile device 1-0 by trilateration is performed using the Time of arrival (TOA).

In another embodiment determination of relative position between a base station and the mobile device 1-0 by trilateration is performed using signal strength analysis.

In another embodiment determination of relative position between a base station and the mobile device 1-0 by multilateration is performed via estimating Time difference of arrival (TDOA).

In yet another embodiment determination of relative position between a base station and the mobile device 1-0 by triangulation is performed via measuring Angles of arrival (AOA) of the signals.

In another embodiment the route computation can be performed by a remote facility or service that has been provided with the reference coordinate points and other data, and instructions, how to process them for the computation of the road distance. In this case the system needs to be equipped with means of transmitting the source data to the remote facility or service and receiving and integrating the processing result.

In another embodiment, the route computation can be performed by a remote facility or service that has been provided with the reference coordinate points and instructions how to process them for the computation of the road distance. In this case, the system is configured to transmit the source data to the remote facility or service and receiving and integrating the processing result.

In a step S 4-8, the road distances computed for the individual directional segments are added up in a way that an overall distance the vehicle carrying the mobile device 1-0 has traveled is computed. This overall distance is associated with the mobile device identification signature. In one embodiment, this procedure is performed by the processor 2-2, but it can also be performed by a remote facility.

In the embodiment of step S 4-9, the mobile device identification signature is used by the processor 2-2 to retrieve from the memory 2-3 billing information associated with the mobile device identification signature. In another embodiment this association of the mobile device identification signature and billing information is performed by a remote facility that receives the distance computations associated with either the respective mobile device identification signature or with a registration number uniquely associated with this signature. At the remote facility this information is then associated with the proper billing information.

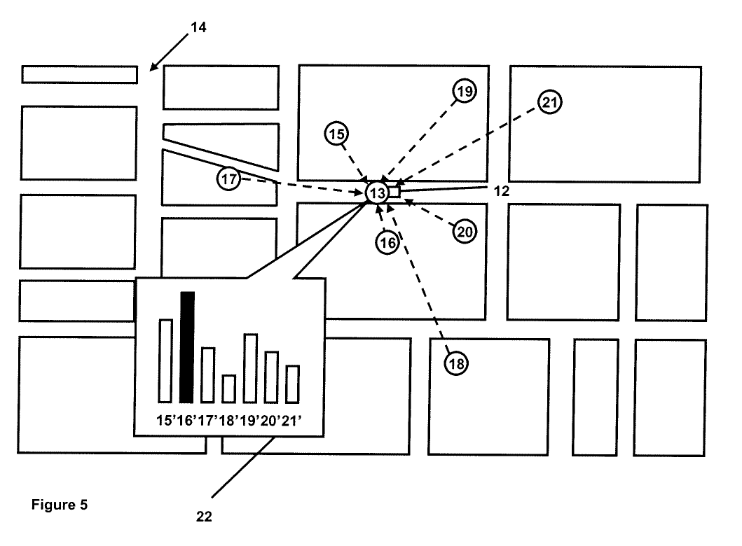

FIG. 5 shows an illustration of one embodiment of a vehicle 12 equipped with the mobile device 1-0 of FIG. 1 and moving within a network of streets 14. The network of streets 14 is superimposed by a network of stationary base stations 15-21. FIG. 5 shows a moment in time when the mobile device 12 receives signals from the stationary base stations 15-21, measures their respective signal strengths and associates this signal strength with the individual base stations identification signatures derived from the signals.

A situation illustrating reception of signals is depicted in FIG. 5 in the form of a signal reception profile 22 that shows the relative received signal strengths 15′ to 21′ of the signals transmitted by base stations 15 to 21. As the vehicle 12 transits the network of streets 14, the profile 22 constantly fluctuates, with the received signal strengths of the individual base stations 15-21 changing, some base stations being dropped from the profile 22 as the vehicle 12 leaves their communication signal radius and new base stations being added, as their communication signal field is crossed. In the situation shown in FIG. 5, the strongest signal at the moment is signal 16′.

FIG. 6 shows an exemplary route 23 a vehicle travels within a network of streets 24. During the entire route 23, the mobile device attached to the vehicle has monitored the base stations identification signatures of available signals and the received signal strength. Points 25′ to 35′ mark the points along the route 23 where the mobile device has recorded that the signals 25′ to 35′ were stronger than the other signals received at that moment.

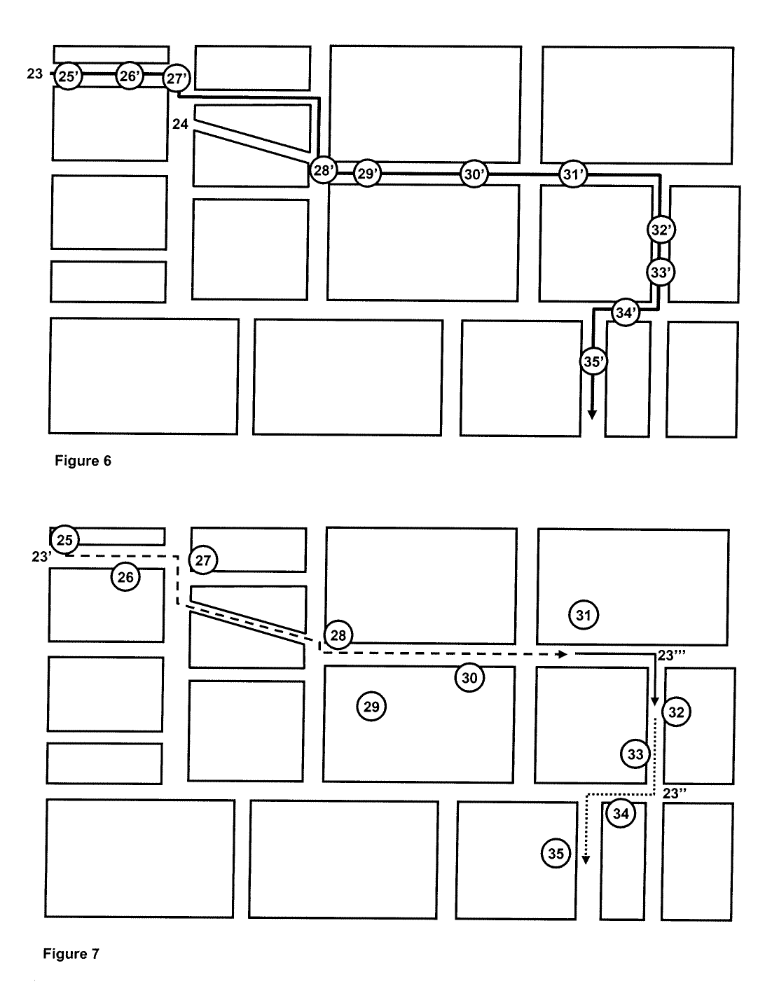

FIG. 7 shows an exemplary street map 24 and the route 23 from FIG. 2 after ascribing base stations identification signatures to their respective positional coordinate points 25 to 35. After performance of a regression analysis on the coordinate points in the sequence of recording, two directional trends crystallize. The first includes coordinate points 25 to 30, the other trend includes coordinate points 31 to 35. In the example of FIG. 5, the first and the last coordinate points forming a directional trend are connected via the shortest street route, forming the routes 23′ and 23″. Then, the last point of route 23′ is connected via the shortest street route to the first point of route 23″ forming the connecting route 23″. The complete distance the vehicle has transited can then be represented approximately by the added street distances of the routes 23′, 23″ and 23″. Other ways to connect the coordinate points to form routes and to calculate the final street distance are detailed in the detailed description of the preferred embodiments. Note that the course of the route 23′ between coordinate points 27 and 28, being the shortest possible street route connecting these points, does not exactly represent the actual route 23 of the vehicle shown in FIG. 6.

What is claimed is:

1. A system for determining a distance a vehicle transits within a road system, comprising:
a mobile device having a unique device identification signature, the mobile device being configured for being attached to the vehicle, wherein the mobile device comprises:
a processing unit configured to process wireless communication signals received from a network of stationary base stations having known positional coordinates and each having a unique base station identity signature encoded into its communication signals, wherein each received communication signal has a received signal strength, the processing unit further configured to process the communication signals to create data sets containing the base stations identity signatures;
a memory coupled to the processing unit and configured to store data sets selected in a way that a sequence of recording these data sets is maintained; and
a transmitter coupled to the processing unit and configured to transmit the sequence of data sets in a way that associates the transmitted data sets to the device identification signature; and
a main processing unit comprising:
a receiver configured to receive the sequence of data sets transmitted by the mobile device;
a processor coupled to the receiver and configured to associate a base station identification signature to the positional coordinates of the base station, to perform a trend analysis upon the positional coordinates, to determine a change in trend, to set route positional coordinates at a change in trend, and to determine the distance the vehicle transits within the road system taking the set route positional coordinates and the road system into account.

2. The system of claim 1, wherein the processor is further configured to associate the device identification signature to billing information for tolling purposes.

3. The system of claim 1, wherein the processor is further configured to take traffic restrictions into account.

4. The system of claim 1, wherein the main processing unit is integrated into the mobile device.

5. The system of claim 1, wherein the main processing unit is situated in a remote processing site.

6. A method of determining a distance a vehicle transits within a road system, wherein the vehicle is provided with a mobile device, the method comprising:
receiving via the mobile device wireless communication signals from a network of stationary base stations having known positional coordinates, each base stations having a unique identity signature encoded into its communication signal;
measuring received signal strengths of received communication signals;
associating the received signal strengths with the identification signatures of the base stations from which the communication signals originate;
associating the identification signatures of the base stations to the positional coordinates of the base stations;
performing a trend analysis upon the positional coordinates to determine a change in trend;
setting route positional coordinates at a change in trend; and
determine the distance the vehicle transits within the road system taking the set route positional coordinates and the road system into account.

7. The method of claim 6, wherein the positional coordinates derived from the communication signals are associated with the respective received signal strength of the communication signals.

8. The method of claim 6, wherein the positional coordinates derived from the communication signals are associated with a Time of arrival of the communication signals at the mobile device.

9. The method of claim 6, wherein the positional coordinates derived from the communication signals are the positional coordinates of the stationary base stations.

10. The method of claim 6, wherein the positional coordinates derived from the communication signals are positional coordinates of the mobile device.

11. The method of claim 6, wherein the received signals from which the positional coordinates are derived are selected from the totality of received signals.

12. The method of claim 6, wherein the trend analysis a regression coefficient analysis.

13. The method of claim 6, wherein the trend analysis is a Least Squares Fit analysis.

14. The method of claim 6, wherein the determined distance represents a shortest road distance between coordinate points.

15. The method of claim 14, wherein more than one potential route between the coordinate points is computed.

16. The method of claim 15, wherein a resulting road distance is an average of the distance via several potential routes computed between the coordinate points.

17. The method of claim 14, wherein reference coordinate points being connected by a route are derived from first and last coordinate points within a segment demarcated by the trend analysis.

18. The method of claim 14, wherein reference coordinate points being connected by a route are derived from first coordinate points of adjoining segments demarcated by the trend analysis.

19. The method of claim 14, wherein several coordinate points demarcated by the trend analysis are used as reference coordinates points.

20. The method of claim 6, wherein a deviation of specified conditions in a trend is a decreasing regression coefficient.

21. The method of claim 20, wherein deviations from the specified conditions and trends are considered to be indicative of a change in direction.

22. The method of claim 6, wherein if no communication signal is received by the mobile device a data set is generated containing an index to a loss of reception.

23. The method of claim 6, wherein successive data sets stored in a data base of the mobile device are provided with an index that indicates a sequence of storage.

24. The method of claim 6, wherein upon detection of a change of direction a new trend analysis is performed, starting with a coordinate set that first indicted this change of direction.
